(19) United States
(12) Patent Application Publication
(10) Pub. No.: US 2026/0164366 A1
(43) Pub. Date: Jun. 11, 2026

(54) MULTI-DEVICE RADIO FREQUENCY EXPOSURE MANAGEMENT

(71) Applicant: Motorola Mobility LLC, Chicago, IL (US)

(72) Inventors: Xuyuan Pan, Chicago, IL (US); Junsheng Zhao, Vernon Hills, IL (US); Md Faisal Abedin, Lisle, IL (US); Mohammed Rajeek Abdul-Gaffoor, Palatine, IL (US)

(73) Assignee: Motorola Mobility LLC, Chicago, IL (US)

(21) Appl. No.: 18/974,392

(22) Filed: Dec. 9, 2024

(51) Int. Cl. H04W 52/36; H04W 52/38

(52) U.S. Cl. CPC H04W 52/365; H04W 52/367; H04W 52/386

(57) ABSTRACT

In aspects of multi-device RF exposure management, a control unit obtains an indication that a set of wireless devices associated with an exposure state are active, where the set of wireless devices contribute to an RF exposure for the exposure state. The control unit transmits, to respective wireless devices of the set of wireless devices, an exposure margin associated with the exposure state. A transmit power of the respective wireless devices satisfies a threshold RF exposure for the exposure state based on the exposure margin. For example, the respective wireless devices use the exposure margin to determine a transmit power that satisfies a threshold RF exposure for the exposure state. The respective wireless devices transmit signaling using the transmit power.

### BACKGROUND

Wireless electronic devices, such as smartphones, smartwatches, smart glasses, and wireless earbuds, can be implemented for use in a wide range of environments and for a variety of different applications. The devices implement various wireless technologies, including Bluetooth, Bluetooth low energy (BLE), Wi-Fi, and cellular connectivity, to provide users with seamless communication and data transfer capabilities. In some examples, the devices may produce radio frequency (RF) emissions during the communication. For example, the devices may radiate electromagnetic energy in the RF portion of the electromagnetic spectrum. RF emissions may be intentionally generated for wireless communication purposes, such as in cellular phones, Wi-Fi routers, or Bluetooth devices, or may be unintentionally produced as a byproduct of electronic device operation. RF emissions can vary in power, frequency, duration, and spatial distribution, and may interact with biological tissues, potentially causing thermal and non-thermal effects. The intensity of RF emissions is often quantified in terms of power density or specific absorption rate (SAR) when considering absorption by a human body.

### BRIEF DESCRIPTION OF THE DRAWINGS

Implementations of the techniques for multi-device RF exposure management are described with reference to the following Figures. The same numbers may be used throughout to reference like features and components shown in the Figures:

FIGS. 1 and 2 illustrate example systems for multi-device RF exposure management in accordance with one or more implementations as described herein.

FIG. 3 illustrates an example exposure diagram for multi-device RF exposure management in accordance with one or more implementations as described herein.

FIG. 4 illustrates an example flowchart for multi-device RF exposure management in accordance with one or more implementations as described herein.

FIGS. 5 and 6 illustrate examples of methods for multi-device RF exposure management in accordance with one or more implementations of the techniques described herein.

FIG. 7 illustrates various components of an example device that can be used to implement the techniques for multi-device RF exposure management as described herein.

### DETAILED DESCRIPTION

Implementations of techniques for multi-device RF exposure management are described herein. In some examples, a system can include multiple wireless electronic devices (e.g., smartphones, smartwatches, smart glasses, wireless earbuds) that contribute to RF exposure for a given exposure state. The devices may implement various wireless technologies, such as Bluetooth, BLE, Wi-Fi, and cellular connectivity. Conventional RF exposure management techniques may account for a single device for a single exposure state. However, as a user interacts with multiple wireless devices concurrently, accounting for a single device may not meet regulatory criterion for combined RF exposure limits. For example, a user may wear smart glasses and use wireless earbuds simultaneously. Both devices may comply with a head SAR requirements individually. However, the combined head SAR from both devices transmitting at the same time may exceed regulatory criterion (e.g., a defined threshold value). Additionally, or alternatively, conventional RF exposure management techniques do not provide a framework for dynamically managing and allocating RF exposure margins across multiple devices based on priorities and communication criterion. This deficiency can lead to suboptimal use of available RF exposure allowances and potential non-compliance with regulatory standards in multi-device usage scenarios.

As described herein, to account for combined RF exposure from multiple devices and to improve allocation of available RF exposure allowances, a system for managing RF exposure across multiple wireless devices implements a control unit to dynamically allocate exposure margins to respective devices. The control unit, which may be integrated into one of the devices or exist as a separate entity (e.g., device), determines a number of active devices contributing to RF exposure for a given state (e.g., head, body, limb). Based on defined weights or learned priorities of communication criterion, the control unit assigns an exposure margin to the respective devices. The devices adjust transmit power levels according to the allocated margins, ensuring the combined RF exposure remains within regulatory limits. This framework enables coordinated power management across multiple devices, adapting to changing usage scenarios and device priorities in real-time.

By considering the aggregate exposure from multiple devices, the system for managing RF exposure more accurately reflects real-world usage scenarios where a user interacts with several wireless devices simultaneously or concurrently. The dynamic allocation of exposure margins provides for regulatory compliance in complex multi-device environments, which single-device management schemes may fail to address. Additionally, or alternatively, the dynamic allocation of exposure margins based on device priorities provides for more efficient use of the available RF exposure allowance, improving overall system performance by enabling higher transmit powers for communications while maintaining safe exposure levels. The flexibility of the control unit implementation also provides for seamless integration into existing device ecosystems without hardware changes.

While features and concepts of the described techniques for multi-device RF exposure management can be implemented in any number of different devices, systems, environments, and/or configurations, implementations of the techniques for multi-device RF exposure management are described in the context of the following example devices, user interfaces, systems, and methods.

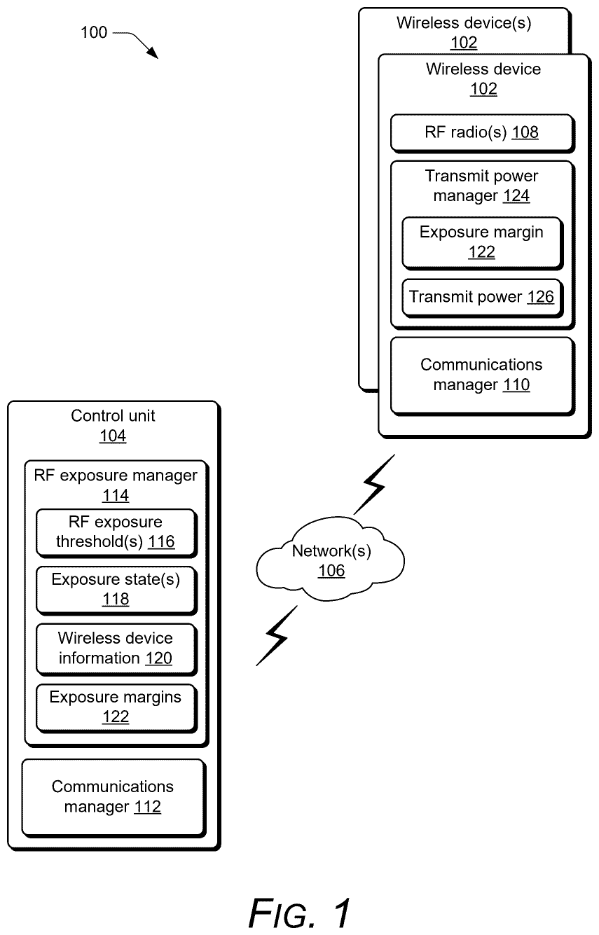

FIG. 1 illustrates an example system 100 for multi-device RF exposure management, as described herein. The example system 100 includes multiple wireless devices 102 and a control unit 104, where the wireless devices 102 and the control unit 104 are interconnectable via one or more networks 106. Although the example system 100 illustrates the wireless devices 102 and the control unit 104 as being separate devices, in some examples, the control unit 104 may be integrated into one or more of the wireless devices 102. The wireless devices 102 may be implemented by a same user. A wireless device 102 and/or a control unit 104 may range from a full resource device with substantial memory and processor resources to a low-resource device with reduced memory and/or processing resources. Although instances in the following discussion refer to a wireless device 102 and a control unit 104 in the singular, a wireless device 102 and a control unit 104 may also be representative of multiple different devices. The wireless devices 102 and the control unit 104 may include one or more features in addition to, or as an alternative to, the features illustrated in the example system 100.

In some examples, a wireless device 102 is an example of a smartphone, a mobile phone, a wireless device, a mobile device, a wearable device, a device mounted (e.g., fixed) in an environment, and/or any other type of device. Wearable devices may include a variety of form factors and functionalities designed to be worn on or close to a body of a user. Examples of wearable devices may include smartwatches, pins, fitness trackers, smart glasses, smart jewelry (rings, necklaces, earrings, etc.), smart clothing (e.g., shirts or shoes with embedded sensors), head-mounted displays, cameras, smart earbuds, and health monitoring devices, among other examples. The wireless device 102 can be implemented with various components, such as a processor system and memory, as well as any number and combination of different components as further described with reference to the example device shown in FIG. 7.

In some examples, the control unit 104 includes a server device, a smartphone, a mobile phone, and/or any other type of wireless device or mobile device capable of managing RF exposure across multiple devices. For example, the control unit 104 may be implemented at a wireless device 102 and/or may be a device independent of the wireless device 102. The control unit 104 can be implemented with various components, such as a processor system and memory, as well as any number and combination of different components as further described with reference to the example device shown in FIG. 7.

In some cases, the wireless device 102 may implement one or more RF radios 108 for transmitting (e.g., outputting, broadcasting) wireless communications. The RF radios 108 may be components within the wireless devices 102 that enable wireless communications using RF signals. Example RF radios 108 may include, but are not limited to, cellular modems for cellular networks, Wi-Fi transceivers, Bluetooth modules, near-field communication (NFC) chips, global positioning system (GPS) receivers, and/or any type of device communication interfaces (e.g., for ultra-wide band (UWB) communication). UWB is a short-range, high-bandwidth wireless communication protocol that operates by transmitting ultra-short pulses over a wide spectrum of frequencies. The wireless devices 102 may use UWB communication to establish high-speed, low-latency connections for rapid data transfer and precise device localization. The wireless devices 102 may use UWB communication to provide centimeter-level accuracy in determining relative positions between devices to enhance detection of RF exposure. A smartphone may utilize a cellular modem to make voice calls or transfer data over a mobile network, while simultaneously using a Wi-Fi radio to connect to a local wireless network. Additionally, or alternatively, a smartwatch might implement a Bluetooth radio to communicate with paired earbuds, while a GPS radio determines the location of a user for fitness tracking purposes.

The RF radios 108 may contribute to RF exposure for a user of the wireless device 102. RF exposure refers to the absorption of radio frequency electromagnetic energy by the human body when in proximity to devices emitting RF signals. The RF radios 108 generate electromagnetic fields during wireless communication processes. The electromagnetic fields interact with biological tissues, which may cause thermal effects through energy absorption. For example, a cellular modem may emit RF radiation during voice calls or data transfers, leading to localized exposure near the head when held to the ear. Wi-Fi transceivers in laptops or tablets may cause RF exposure to the body when devices are used on the lap. Bluetooth modules in wireless earbuds may result in exposure to the head region due to their close proximity. The level of RF exposure may depend on various factors, such as a transmit power, a frequency of operation, a duration of use, and a distance from a user. The control unit 104 may manage RF exposure for multiple active RF radios 108 in various wireless devices 102 that are used concurrently, as the wireless devices 102 may contribute to cumulative RF exposure.

In some examples, a wireless device 102 and a control unit 104 may implement a communications manager 110 and a communications manager 112, respectively. The communications manager 110 at the wireless device 102 and the communications manager 112 at the control unit 104 may facilitate the exchange of information related to RF exposure management. The communications manager 110 at the wireless device 102 may be responsible for establishing and maintaining connections with the control unit 104, transmitting device status updates, and receiving exposure margin allocations. The communications manager 110 may also handle the encoding and transmission of device information, such as current (e.g., actual) transmit power levels, a device type of the wireless device 102, active radio technologies, and proximity to a user. The communications manager 112 at the control unit 104 may manage connections with multiple wireless devices 102, receive and process status updates from the wireless devices 102, and distribute exposure margin allocations to the wireless devices 102. The communications manager 112 may also implement security protocols to ensure encrypted and authenticated data transfer between the control unit 104 and the wireless devices 102.

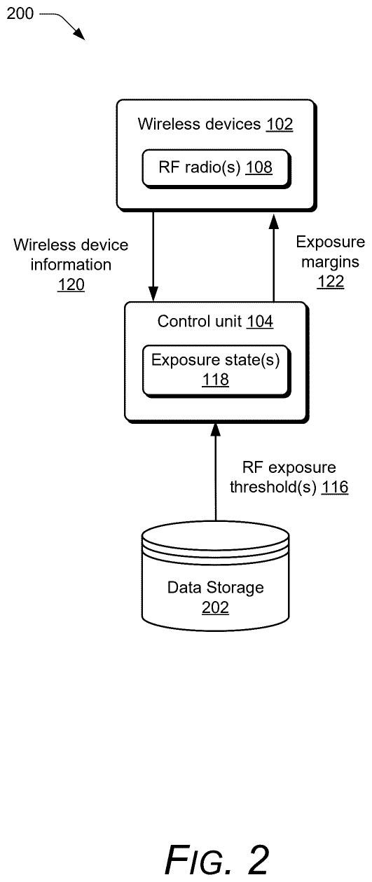

The control unit 104 may implement an RF exposure manager 114 to control (e.g., manage, coordinate, regulate) RF exposure across multiple wireless devices 102. The RF exposure manager 114 may obtain RF exposure thresholds 116, which are defined limits for RF exposure in various scenarios (e.g., exposure states 118). The RF exposure thresholds 116 may be configured (e.g., defined, preconfigured, predefined) by a third-party, including regulatory organizations. The control unit 104 may obtain the RF exposure thresholds 116 from one or more databases, which is described in further detail with respect to FIG. 2, or via secure channels (e.g., where they may be updated periodically). For example, the RF exposure manager 114 may store an RF exposure threshold 116 of 1.6 Watts per kilogram (W/kg) for a localized SAR in the head and trunk for general public exposure.

In some cases, the RF exposure thresholds 116 may apply for different exposure states 118. Exposure states 118 refer to a current usage scenario of the wireless devices 102 in relation to a body of a user. The control unit 104 may determine the exposure states 118 based on wireless device information 120 received from the wireless devices 102 (e.g., via the networks 106). Examples of exposure states 118 may include, but are not limited to, head exposure (e.g., when using a smartphone near the ear or wearing smart glasses), body exposure (e.g., a smartphone in a pocket), or limb exposure (e.g., a smartwatch on the wrist). The wireless device information 120 may include various details about the wireless devices 102 that are relevant to RF exposure management. The control unit 104 may determine the wireless device information 120 through direct communication with the wireless devices 102. Example wireless device information 120 may include, but is not limited to, a device type of the wireless device 102 (e.g., smartphone, smartwatch, wireless earbuds), one or more active radio technologies at the wireless device 102, a current transmit power level at the wireless device 102, and a relative position of the device to a body of a user.

The RF exposure manager 114 may calculate (e.g., determine, obtain) exposure margins 122 for the wireless devices 102 that do not exceed the RF exposure thresholds 116 for the exposure states 118. The exposure margins 122 are allocations of an RF exposure assigned to respective wireless devices 102. The RF exposure manager 114 calculates the exposure margins 122 by the using the RF exposure thresholds 116 for the current exposure states 118, taking into account the wireless device information 120. For example, if an RF exposure threshold 116 for head exposure is 1.6 W/kg, the RF exposure manager 114 might allocate an exposure margin of 0.8 W/kg to a smartphone and 0.4 W/kg each to a pair of wireless earbuds, ensuring the combined exposure remains below the RF exposure threshold 116. In some cases, the control unit 104 transmits (e.g., sends, forwards) the exposure margins to respective wireless devices 102 (e.g., via the networks 106 and/or internal circuitry if the wireless device 102 implements the control unit 104).

A wireless device 102 may receive an exposure margin 122 allocated to the wireless device 102. The wireless device 102 may implement a transmit power manager 124 to determine a transmit power 126 according to the exposure margin 122. The transmit power manager 124 may implement one or more algorithms to improve power usage while ensuring compliance with the exposure margin 122. For example, if a smartphone receives an exposure margin 122 that is reduced due to the simultaneous use of wireless earbuds, the transmit power manager 124 may lower a power output (e.g., transmit power 126) of a cellular modem during a voice call, while maintaining sufficient signal quality.

In some cases, in addition to, or as an alternative to, transmit power 126, a wireless device 102 may adjust various factors based on an exposure margin 122 received from the control unit 104. For example, the wireless device 102 may modify (e.g., lower) a data transmission rate to reduce overall RF emissions while maintaining connectivity. The wireless device 102 may also adjust an active cycle, alternating between active transmission periods and idle periods to reduce average RF exposure over time. In some examples, the wireless device 102 may switch between different frequency bands or wireless technologies to lower associated RF exposure levels. The wireless device 102 may also implement adaptive antenna techniques, adjusting antenna patterns to direct RF energy more efficiently and minimize unnecessary exposure. Additionally, or alternatively, the wireless device 102 may modify one or more power control algorithms to increase the frequency of power adjustments to more closely track the exposure margin 122. In some cases, the wireless device 102 may prioritize or deprioritize one or more types of data transmissions, delaying non-critical updates to reduce overall RF emissions. The wireless device 102 may also adjust a sleep mode duration or frequency, which may increase periods of low or no RF transmission. The adjustments of the various factors may be implemented individually or in combination, providing for the wireless device 102 to maintain one or more performance metrics, while adhering to the exposure margin 122.

The RF exposure manager 114 at the control unit 104 provides centralized management of RF exposure, ensuring that the combined exposure from the wireless devices 102 remains within the RF exposure thresholds (e.g., regulatory limits). By dynamically allocating exposure margins 122 based on real-time device usage and priorities, the system 100 may improve RF performance while maintaining safety. The transmit power manager 124 in each wireless device 102 provides fine-grained control over RF emissions, adapting to allocated margins without compromising functionality. This coordinated approach may enhance user safety, improve device performance, and ensure regulatory compliance in increasingly complex multi-device environments.

FIG. 2 illustrates an example system 200 for multi-device RF exposure management in accordance with one or more implementations as described herein. The example system 200 may implement aspects of the example system 100. For example, the example system 200 may be implemented by multiple wireless devices 102, a control unit 104, and a data storage 202 to facilitate management of RF exposure across multiple wireless devices, where the wireless devices 102 and the control unit 104 may be examples of the corresponding devices and components as described with reference to FIG. 1.

In some examples, the wireless devices 102 communicate wireless device information 120 to the control unit 104. The control unit 104 may process the wireless device information 120, as well as one or more exposure states 118 and RF exposure thresholds 116 to calculate exposure margins 122 for the wireless devices 102. For example, the control unit 104 may determine a numerical quantity of active wireless devices 102 contributing to RF exposure for an exposure state 118, as described with reference to FIG. 1. The control unit 104 transmits the calculated exposure margins 122 to the wireless devices 102, which provides for the wireless devices 102 to adjust transmit power levels, accordingly.

In some examples, the control unit 104 may query (e.g., access) a data storage 202 to obtain RF exposure thresholds 116 for different exposure states 118. The data storage 202 may refer to a component or system for storing and retrieving digital information related to RF exposure management. Example data storage 202 may include, but is not limited to, solid-state drives, hard disk drives, cloud storage services, databases, and memory arrays. In the context of this invention, the data storage 202 may store RF exposure thresholds 116, which are used by the control unit 104 to calculate appropriate exposure margins 122 for the wireless devices 102. For example, the data storage 202 may include a database of regulatory limits for different exposure states 118, such as head, body, and limb exposure, across various frequency bands and device types. Additionally, or alternatively, the data storage 202 may store historical data on device usage patterns and corresponding RF exposure levels, which the control unit 104 may use to adjust exposure margin allocations. The data storage 202 may maintain records of wireless device information 120 received from various devices, providing for the control unit 104 to track changes in the RF exposure environment over time and adjust RF exposure management techniques, accordingly.

The information stored in the data storage 202 may be updated through various mechanisms to ensure an accuracy and a relevance of the information. In some cases, the control unit 104 or another device may initiate periodic updates to the information in the data storage 202 by querying regulatory databases or official sources for current RF exposure thresholds 116 and guidelines. The updates may occur on a scheduled basis, such as weekly, monthly, or quarterly, depending on the frequency of regulatory changes. Additionally, or alternatively, the system 200 may implement real-time update capabilities, providing for synchronization when new regulations or standards are published. In some cases, the data storage 202 may receive notifications from authorized regulatory bodies, prompting automatic updates to the stored information. The system 200 may also incorporate machine learning algorithms to analyze usage patterns and RF exposure data collected from the wireless devices 102, potentially refining and updating exposure models stored in the data storage 202.

For example, the control unit 104 may utilize machine learning algorithms to analyze historical data on device usage patterns, RF emission levels, and exposure margins 122 to predict future exposure scenarios (e.g., exposure states 118). Predicting future exposure states 118 may provide for proactive adjustments to exposure margins 122 before RF exposure threshold 116 violations occur. In some cases, reinforcement learning models may be implemented to improve the allocation of exposure margins 122 across multiple wireless devices 102. These models may learn over time to balance RF performance and RF exposure thresholds 116 more effectively, adapting to changing usage patterns and device priorities. The control unit 104 may employ neural networks to process complex, multi-dimensional data from various wireless devices 102 and to identify patterns or correlations in RF exposure, which may lead to improved exposure management techniques using the patterns or correlations.

In some examples, the control unit 104 may calculate the exposure margins 122 by assessing one or more exposure states 118 for a user of the wireless devices 102 and the corresponding RF exposure threshold 116 for the exposure states 118. The control unit 104 may analyze the wireless device information 120 received from active wireless devices 102, including device types, active radio technologies, and current transmit power levels. Using this information, the control unit 104 may estimate the individual contribution of respective wireless devices 102 to the overall RF exposure. For example, the control unit 104 may employ mathematical models or lookup tables to translate device characteristics and usage patterns into estimated exposure levels. The control unit 104 may additionally, or alternatively, consider the relative priorities of different wireless devices 102 or communication tasks, and may allocate relatively greater exposure margins 122 to devices or functions with higher priorities.

The control unit 104 may divide an available exposure budget (e.g., based on the RF exposure threshold 116) among the active wireless devices 102, taking into account communications at the wireless devices 102 and priorities of the communication and/or the wireless devices 102. In some cases, the control unit 104 may use historical data and machine learning algorithms to predict future exposure patterns and adjust the exposure margins 122, accordingly. The control unit 104 may also incorporate feedback mechanisms, using real-time data from the wireless devices 102 to fine-tune the calculations. The control unit 104 may apply safety factors or conservative estimates to ensure that the combined exposure from the wireless devices 102 remains below the RF exposure threshold for different exposure states 118, even in dynamic usage scenarios. The control unit 104 may perform the calculation process continuously or at regular intervals to adapt to changing states of the wireless devices 102 and user behaviors.

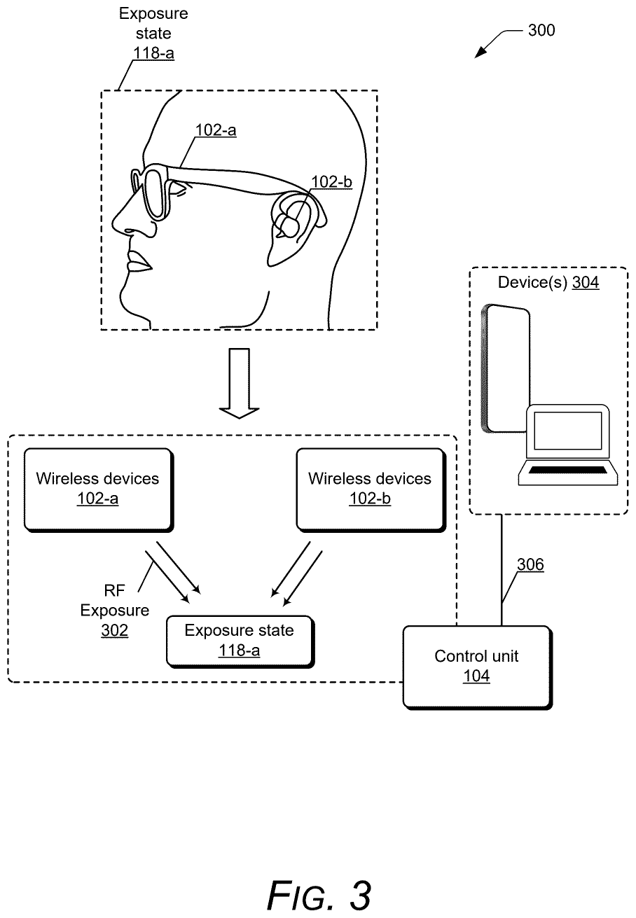

FIG. 3 illustrates an example exposure diagram 300 for managing RF exposure across multiple wireless devices in accordance with one or more implementations as described herein. The exposure diagram 300 may implement aspects of the system 100 and the system 200. For example, the exposure diagram 300 may be implemented by multiple wireless devices (e.g., the wireless device 102-a and the wireless device 102-b) and a control unit 104 to facilitate management of RF exposure 302 across the multiple wireless devices, where the wireless devices and the control unit 104 may be examples of the corresponding devices and components as described with reference to FIGS. 1 and 2.

The exposure diagram 300 represents an exposure state 118-a, which may be an example of a head exposure state. There may be two wireless devices within the exposure state 118-a. For example, the exposure state 118-a may include a wireless device 102-a, which may be an example of smart glasses, and a wireless device 102-b, which may be an example of wireless earbuds or headphones. The wireless device 102-a and the wireless device 102-b contribute to an RF exposure 302 within the exposure state 118-a. That is, multiple devices simultaneously affect the RF exposure 302 for an exposure state 118-a.

A control unit 104 may manage the RF exposure 302 of the wireless device 102-a and the wireless device 102-b to ensure the RF exposure 302 satisfies a threshold value (e.g., a defined value) for the exposure state 118-a. The control unit 104 may be implemented by, or may include one or more devices 304, such as via a communication link 306. The communication link 306 may be implemented as an over-the-air wireless link or a physical wired connection, which may provide for the devices 304 to implement the control unit 104. The devices 304 may be examples of a smartphone, a laptop, a tablet, or another mobile device capable of managing RF exposure across multiple wireless devices. Additionally, or alternatively, the wireless device 102-a and/or the wireless device 102-b may implement the control unit 104. The control unit 104 may manage the wireless device 102-a and the wireless device 102-b by monitoring the RF exposure 302 and indicating for the wireless device 102-a and/or the wireless device 102-b to adjust communication parameters to maintain RF exposure 302 below a threshold value for the exposure state 118-a.

For the wireless device 102-a and the wireless device 102-b, an exposure margin is defined as E_{A} and E_{B}, respectively (e.g., 0≤E_{A}, E_{B}≤1). In some cases, when E_{A}=1 or E_{B}=1, the maximum transmit power for the wireless device 102-a and the wireless device 102-b (e.g., without exceeding a regulatory limit or threshold value) is P_{A}_{ₗᵢₘᵢₜ} and P_{B}_{ₗᵢₘᵢₜ}, respectively.

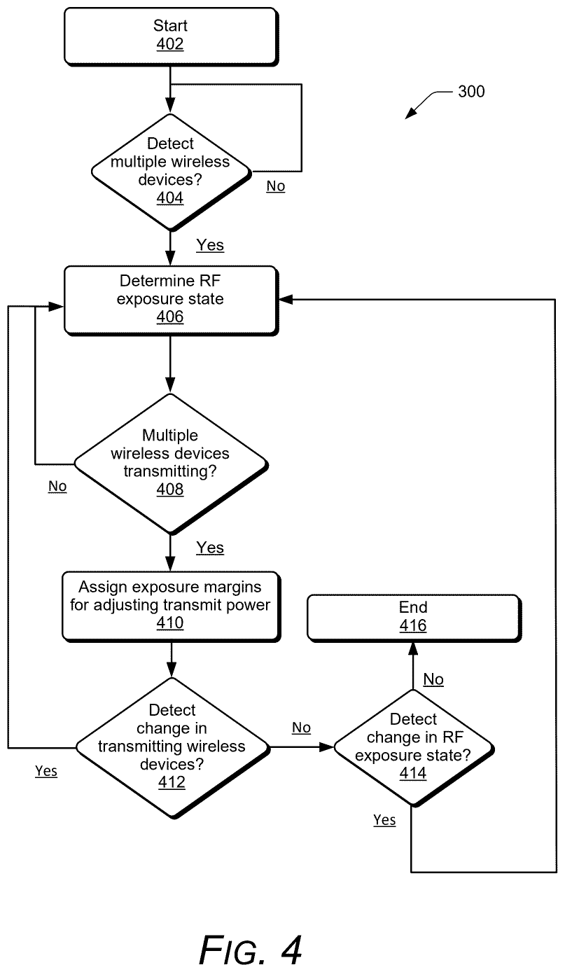

FIG. 4 illustrates an example flowchart 400 for multi-device RF exposure management in accordance with one or more implementations as described herein. The flowchart 400 may implement aspects of the system 100, as well as any of the system 200, and the exposure diagram 300. For example, the flowchart 400 can be implemented by a control unit, which may be an example of the control unit 104 as described with reference to FIGS. 1 through 3. Alternative examples of the following may be implemented, where some processes are performed in a different order than described or are not performed. In some cases, processes may include additional features not mentioned below, or further processes may be added.

At 402, management of RF exposure begins. For example, a control unit (e.g., the control unit 104 as described with reference to FIGS. 1 through 3) may initiate RF exposure management based on a request and/or periodically.

At 404, a determination is made as to whether multiple wireless devices are detected. For example, a control unit may detect the presence of multiple wireless devices (e.g., wireless devices 102 as described with reference to FIGS. 1 through 3) for an exposure state. If multiple devices are not detected (e.g., “No”), then the control unit may continue monitoring for the presence of multiple devices.

At 406, if multiple devices are detected (e.g., “Yes”), then the RF exposure state is determined. For example, the control unit may assess a current usage scenario of the wireless devices in relation to a body of a user, such as head exposure, body exposure, or limb exposure.

At 408, a determination is made as to whether multiple wireless devices are transmitting. For example, the control unit may analyze wireless device information received from the detected devices to determine which devices are actively transmitting. If multiple devices are not transmitting (e.g., “No”), then the control unit reassess the RF exposure state at 406.

At 410, if multiple devices are transmitting (e.g., “Yes”), then exposure margins for adjusting transmit power are assigned to the devices. For example, the control unit may calculate and allocate exposure margins to each transmitting device based on the determined RF exposure state, RF exposure thresholds, and device priorities. The control unit may determine N devices are transmitting, and may calculate exposure margins for a device, i, such that a sum of the exposure margins for the devices is equal to one (e.g., for i=1, . . . , N; 0≤Eᵢ≤1; ΣEᵢ=1). The control unit may transmit the exposure margins to the devices (e.g., the wireless devices), and the devices may adjust the transmit power according to the exposure margins to satisfy a threshold exposure for the exposure state.

At 412, the process detects any changes in transmitting wireless devices. For example, the control unit may continuously monitor the wireless devices for changes in their transmission status and/or the addition or removal of devices. If changes are detected (e.g., “Yes”), then the process returns to 406 to reassess the RF exposure state.

At 414, if no changes in transmitting devices are detected (e.g., “No”), then changes in the RF exposure state are checked. For example, the control unit may monitor for changes in a device usage of a user or position that may affect the exposure state. If a change is detected (e.g., “Yes”), the control unit returns to 406 to determine the RF exposure state.

At 416, if no change in the RF exposure state is detected (e.g., “No”), then the management of RF exposure process ends.

The example flowchart 400, as well as example methods 500 and 600, are described with reference to respective FIGS. 4 through 6 in accordance with one or more implementations of multi-device RF exposure management, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

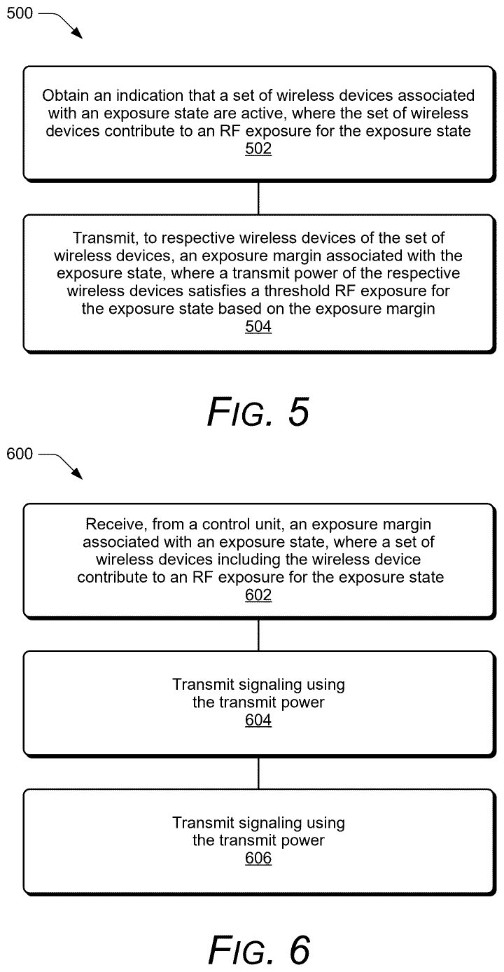

FIG. 5 illustrates one or more example methods 500 for multi-device RF exposure management. The order in which the method is described is not intended to be construed as a limitation, and any number or combination of the described method operations can be performed in any order to perform a method, or an alternate method.

At 502, an indication that a set of wireless devices associated with an exposure state are active is obtained. In some examples, the set of wireless devices contribute to an RF exposure for the exposure state. For example, a control unit may obtain the indication that the set of wireless devices are active from the wireless devices (e.g., via over-the-air signaling between the wireless devices and the control unit and/or via internal circuitry if the wireless devices implement the control unit).

At 504, an exposure margin associated with the exposure state is transmitted to respective wireless devices of the set of wireless devices. A transmit power of the respective wireless devices satisfies a threshold RF exposure for the exposure state based on the exposure margin. For example, the control unit may transmit the exposure margin to the wireless devices via over-the-air signaling or via internal circuitry. The control unit may determine a device type of the respective wireless devices, where the exposure margin is different for different device types of the respective wireless devices. For example, the exposure margin may be greater for device types with higher priority signaling and/or that are higher priority devices (e.g., devices for emergency communication, among other examples).

In some examples, the control unit may receive feedback from at least one wireless device of the set of wireless devices. The feedback may indicate a transmit power (e.g., a current transmit power, an actual transmit power) used by the wireless device. The control unit may transmit an updated exposure margin to the respective wireless devices according to the feedback. For example, if the transmit power causes the RF exposure to exceed a threshold value, then the control unit may decrease the exposure margin of the wireless devices, accordingly. In some other examples, if the transmit power causes the RF exposure to be below the threshold value, then the control unit may increase the exposure margin of the wireless devices (e.g., to improve performance of the wireless device, such as signal quality), accordingly.

In some examples, the control unit may detect a change in a numerical quantity of wireless devices contributing to the RF exposure for the exposure state. The control unit may transmit an updated exposure margin to the respective wireless devices, accordingly. For example, if additional devices are contributing to the RF exposure, then the control unit may decrease the exposure margin for the wireless devices to accommodate the additional devices. In some other examples, if devices stop (e.g., terminate) contributing to the RF exposure, then the control unit may increase the exposure margin for the remaining wireless devices.

In some cases, the control unit may be integrated into a wireless device. In some other cases, the control unit may be independent of the wireless devices, such as integrated into another device or standalone hardware and software (e.g., a device). The exposure state may be at least one of a head exposure state, a body exposure state, or a limb exposure state, among other examples.

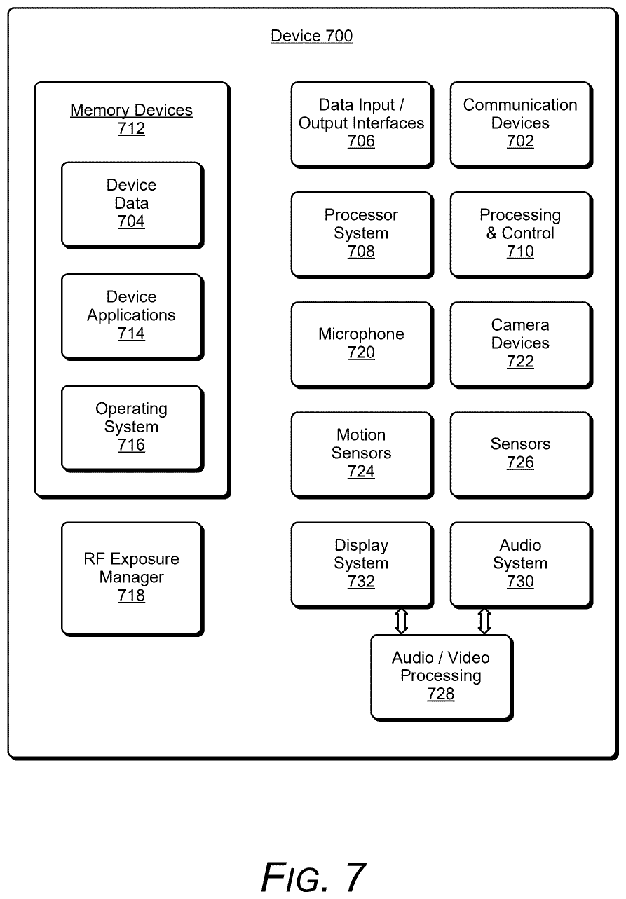

FIG. 6 illustrates one or more example methods 600 for multi-device RF exposure management. The order in which the method is described is not intended to be construed as a limitation, and any number or combination of the described method operations can be performed in any order to perform a method, or an alternate method.

At 602, an exposure margin associated with an exposure state is received from a control unit. A set of wireless devices including the wireless device contribute to an RF exposure for the exposure state. For example, a wireless device receives the exposure margin from the control unit.

At 604, a transmit power that satisfies a threshold RF exposure for the exposure state is determined based on the exposure margin. For example, the wireless device may select (e.g., determine, obtain, identify) a transmit power, among other example transmission characteristics, that satisfies the threshold RF exposure for transmitting signaling.

At 606, signaling is transmitted using the transmit power. For example, the wireless device transmits (e.g., outputs, exchanges, communicates) signaling that satisfies the threshold RF exposure by adjusting the transmit power to the determined transmit power.

In some cases, the wireless device transmits feedback indicating the transmit power to the control unit. The wireless device may transmit the feedback periodically or in response to a change in the transmit power exceeding a threshold value for the threshold RF exposure. In some examples, the wireless device determines a device type and transmits the device type to the control unit. Example device types include, but are not limited to, smartphones, smartwatches, smart glasses, wireless earbuds, fitness trackers, tablets, laptops, portable gaming consoles, wireless headphones, and body-worn health monitoring devices, among other examples.

In some examples, the wireless device detects a change in an operating state of the wireless device and transmits an indication of the change to the control unit. The change in the operating state may include, but is not limited to, activation or deactivation of a wireless communication technology at the wireless device (cellular, Wi-Fi, Bluetooth, UWB, etc.), a change in proximity of the wireless device to a user, or a change in orientation of the wireless device relative to the user. The wireless device may include one or more proximity sensors, or other sensors, to detect the proximity of the wireless device to the user. The wireless device may include one or more accelerometers or other positioning sensors to detect the orientation of the wireless device relative to the user.

FIG. 7 illustrates various components of an example device 700, which can implement aspects of the techniques and features for multi-device RF exposure management, as described herein. The example device 700 can be implemented as any of the devices described with reference to the previous FIGS. 1 through 6, such as any type of a wireless device, mobile device, mobile phone, flip phone, client device, companion device, paired device, display device, tablet, wearable device, computing, communication, entertainment, gaming, media playback, and/or any other type of computing, consumer, and/or electronic device. For example, the wireless device 102 and/or the control unit 104 described with reference to FIGS. 1 through 6 may be implemented as the example device 700.

The example device 700 can include various, different communication devices 702 that enable wired and/or wireless communication of device data 704 with other devices. The device data 704 can include any of the various device's data and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input/output (I/O) interfaces 706, such as data network interfaces that provide connection and/or communication links between the devices, data networks, and other devices. The I/O interfaces 706 can be used to couple the device to any type of components, peripherals, and/or accessory devices, such as a computer input device that may be integrated with the example device 700. The I/O interfaces 706 may also include data input ports via which any type of data, information, media content, communications, messages, and/or inputs can be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that may be implemented in connection with processing and control circuits, which are generally identified as processing and control 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 712 include volatile memory and non-volatile memory, fixed and removable media devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage media device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 can be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In this example, the device 700 includes an RF exposure manager 718 that implements various aspects of the described features and techniques described herein. The RF exposure manager 718 can be implemented with hardware components and/or in software as one of the device applications 714, such as when the example device 700 is implemented as the wireless device 102 and/or the control unit 104 described with reference to FIGS. 1 through 6. An example of the RF exposure manager 718 is the RF exposure manager 114 implemented at the control unit 104, such as a software application and/or as hardware components in the wireless device. In one or more implementations, the RF exposure manager 718 may include independent processing, memory, and logic components as a computing and/or electronic device integrated with the example device 700.

The example device 700 can also include a microphone 720 and/or camera devices 722, as well as proximity and/or motion sensors 724, such as may be implemented as components of an inertial measurement unit (IMU), and geographical location information sensors (e.g., GPS to obtain a current geographic location of the client device or a user of the client device). The proximity and/or motion sensors 724 can be implemented with various sensors 726, such as a gyroscope, an accelerometer, and/or other types of motion sensors to sense motion of the device. The motion sensors 724 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources, such as when the device is implemented as a wireless device 102 and/or a control unit 104. The power sources may include a charging and/or power system, and can be implemented as a flexible strip battery, a rechargeable battery, a charged super-capacitor, and/or any other type of active or passive power source.

The example device 700 can also include an audio and/or video processing system 728 that generates audio data for an audio system 730 and/or generates display data for a display system 732. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In one or more implementations, the audio system and/or the display system are integrated components of the example device 700. Additionally, or alternatively, the audio system and/or the display system are external, peripheral components to the example device.

In some aspects, the techniques described herein relate to a control unit including at least one memory, and at least one processor coupled with the at least one memory and configured to cause the control unit to obtain an indication that a plurality of wireless devices associated with an exposure state are active, where the plurality of wireless devices contribute to an RF exposure for the exposure state, and transmit, to respective wireless devices of the plurality of wireless devices, an exposure margin associated with the exposure state, where a transmit power of the respective wireless devices satisfies a threshold RF exposure for the exposure state based on the exposure margin.

In some aspects, the techniques described herein relate to a control unit, where the at least one processor is further configured to cause the control unit to receive, from at least one wireless device of the plurality of wireless devices, feedback indicating the transmit power, and transmit, to the respective wireless devices of the plurality of wireless devices, an updated exposure margin associated with the exposure state based on the feedback.

In some aspects, the techniques described herein relate to a control unit, where the at least one processor is further configured to cause the control unit to determine a device type of the respective wireless devices, where the exposure margin is based on the device type of the respective wireless devices.

In some aspects, the techniques described herein relate to a control unit, where the at least one processor is further configured to cause the control unit to detect a change in a numerical quantity of the plurality of wireless devices contributing to the RF exposure for the exposure state, and transmit, to the respective wireless devices of the plurality of wireless devices, an updated exposure margin associated with the exposure state based on the change.

In some aspects, the techniques described herein relate to a control unit, where the control unit is integrated into a wireless device of the plurality of wireless devices.

In some aspects, the techniques described herein relate to a control unit, where the control unit is independent of the plurality of wireless devices.

In some aspects, the techniques described herein relate to a control unit, where the exposure state is at least one of a head exposure state, a body exposure state, or a limb exposure state.

In some aspects, the techniques described herein relate to a wireless device including at least one memory, and at least one processor coupled with the at least one memory and configured to cause the wireless device to receive, from a control unit, an exposure margin associated with an exposure state, where a plurality of wireless devices including the wireless device contribute to a radio frequency (RF) exposure for the exposure state, determine, based on the exposure margin, a transmit power that satisfies a threshold RF exposure for the exposure state, and transmit signaling using the transmit power.

In some aspects, the techniques described herein relate to a wireless device, where the at least one processor is further configured to cause the wireless device to transmit, to the control unit, feedback indicating the transmit power.

In some aspects, the techniques described herein relate to a wireless device, where the feedback is transmitted periodically or in response to a change in the transmit power exceeding a threshold value corresponding to the threshold RF exposure.

In some aspects, the techniques described herein relate to a wireless device, where the at least one processor is further configured to cause the wireless device to determine a device type of the wireless device and transmit the device type to the control unit.

In some aspects, the techniques described herein relate to a wireless device, where the at least one processor is further configured to cause the wireless device to detect a change in an operating state of the wireless device and transmit an indication of the change in the operating state to the control unit.

In some aspects, the techniques described herein relate to a wireless device, where the change in the operating state includes at least one of activation or deactivation of a wireless communication technology at the wireless device, a change in proximity of the wireless device to a user, or a change in orientation of the wireless device relative to the user.

In some aspects, the techniques described herein relate to a method performed by a control unit, the method including obtaining an indication that a plurality of wireless devices associated with an exposure state are active, where the plurality of wireless devices contribute to a radio frequency (RF) exposure for the exposure state, and transmitting, to respective wireless devices of the plurality of wireless devices, an exposure margin associated with the exposure state, where a transmit power of the respective wireless devices satisfies a threshold RF exposure for the exposure state based on the exposure margin.

In some aspects, the techniques described herein relate to a method, further including receiving, from at least one wireless device of the plurality of wireless devices, feedback indicating the transmit power, and transmitting, to the respective wireless devices of the plurality of wireless devices, an updated exposure margin associated with the exposure state based on the feedback.

In some aspects, the techniques described herein relate to a method, further including determining a device type of the respective wireless devices, where the exposure margin is based on the device type of the respective wireless devices.

In some aspects, the techniques described herein relate to a method, further including detect a change in a numerical quantity of the plurality of wireless devices contributing to the RF exposure for the exposure state, and transmit, to the respective wireless devices of the plurality of wireless devices, an updated exposure margin associated with the exposure state based on the change.

In some aspects, the techniques described herein relate to a method, where the control unit is integrated into a wireless device of the plurality of wireless devices.

In some aspects, the techniques described herein relate to a method, where the control unit is independent of the plurality of wireless devices.

In some aspects, the techniques described herein relate to a method, where the exposure state is at least one of a head exposure state, a body exposure state, or a limb exposure state.

1. A control unit, comprising:
at least one memory; and
at least one processor coupled with the at least one memory and configured to cause the control unit to:
obtain an indication that a plurality of wireless devices associated with an exposure state are active, wherein the plurality of wireless devices contribute to a radio frequency (RF) exposure for the exposure state; and
transmit, to respective wireless devices of the plurality of wireless devices, an exposure margin associated with the exposure state, wherein a transmit power of the respective wireless devices satisfies a threshold RF exposure for the exposure state based at least in part on the exposure margin.

2. The control unit of claim 1, wherein the at least one processor is further configured to cause the control unit to:
receive, from at least one wireless device of the plurality of wireless devices, feedback indicating the transmit power; and
transmit, to the respective wireless devices of the plurality of wireless devices, an updated exposure margin associated with the exposure state based at least in part on the feedback.

3. The control unit of claim 1, wherein the at least one processor is further configured to cause the control unit to determine a device type of the respective wireless devices, wherein the exposure margin is based at least in part on the device type of the respective wireless devices.

4. The control unit of claim 1, wherein the at least one processor is further configured to cause the control unit to:
detect a change in a numerical quantity of the plurality of wireless devices contributing to the RF exposure for the exposure state; and
transmit, to the respective wireless devices of the plurality of wireless devices, an updated exposure margin associated with the exposure state based at least in part on the change.

5. The control unit of claim 1, wherein the control unit is integrated into a wireless device of the plurality of wireless devices.

6. The control unit of claim 1, wherein the control unit is independent of the plurality of wireless devices.

7. The control unit of claim 1, wherein the exposure state is at least one of a head exposure state, a body exposure state, or a limb exposure state.

8. A wireless device comprising:
at least one memory; and
at least one processor coupled with the at least one memory and configured to cause the wireless device to:
receive, from a control unit, an exposure margin associated with an exposure state, wherein a plurality of wireless devices comprising the wireless device contribute to a radio frequency (RF) exposure for the exposure state;
determine, based at least in part on the exposure margin, a transmit power that satisfies a threshold RF exposure for the exposure state; and
transmit signaling using the transmit power.

9. The wireless device of claim 8, wherein the at least one processor is further configured to cause the wireless device to transmit, to the control unit, feedback indicating the transmit power.

10. The wireless device of claim 9, wherein the feedback is transmitted periodically or in response to a change in the transmit power exceeding a threshold value corresponding to the threshold RF exposure.

11. The wireless device of claim 8, wherein the at least one processor is further configured to cause the wireless device to:
determine a device type of the wireless device; and
transmit the device type to the control unit.

12. The wireless device of claim 8, wherein the at least one processor is further configured to cause the wireless device to:
detect a change in an operating state of the wireless device; and
transmit an indication of the change in the operating state to the control unit.

13. The wireless device of claim 12, wherein the change in the operating state comprises at least one of activation or deactivation of a wireless communication technology at the wireless device, a change in proximity of the wireless device to a user, or a change in orientation of the wireless device relative to the user.

14. A method performed by a control unit, the method comprising:
obtaining an indication that a plurality of wireless devices associated with an exposure state are active, wherein the plurality of wireless devices contribute to a radio frequency (RF) exposure for the exposure state; and
transmitting, to respective wireless devices of the plurality of wireless devices, an exposure margin associated with the exposure state, wherein a transmit power of the respective wireless devices satisfies a threshold RF exposure for the exposure state based at least in part on the exposure margin.

15. The method of claim 14, further comprising:
receiving, from at least one wireless device of the plurality of wireless devices, feedback indicating the transmit power; and
transmitting, to the respective wireless devices of the plurality of wireless devices, an updated exposure margin associated with the exposure state based at least in part on the feedback.

16. The method of claim 14, further comprising determining a device type of the respective wireless devices, wherein the exposure margin is based at least in part on the device type of the respective wireless devices.

17. The method of claim 14, further comprising:
detect a change in a numerical quantity of the plurality of wireless devices contributing to the RF exposure for the exposure state; and
transmit, to the respective wireless devices of the plurality of wireless devices, an updated exposure margin associated with the exposure state based at least in part on the change.

18. The method of claim 14, wherein the control unit is integrated into a wireless device of the plurality of wireless devices.

19. The method of claim 14, wherein the control unit is independent of the plurality of wireless devices.

20. The method of claim 14, wherein the exposure state is at least one of a head exposure state, a body exposure state, or a limb exposure state.
